(19) United States
(12) Patent Application Publication
(10) Pub. No.: US 2016/0050461 A1
(43) Pub. Date: Feb. 18, 2016

(54) DIGITAL TELEVISION WITH SOCIAL NETWORKING APPLICATIONS

(71) Applicants: Xutong Hu, Anhui (CN); Hsi-Kang TSAO, Taipel City, Taiwan (CN)

(72) Inventors: Xutong HU, Hefei, Anhui (CN); Hsi-Kang TSAO, Taipei City (TW)

(21) Appl. No.: 14/779,700

(22) PCT Filed: May 27, 2013
(86) PCT No.: PCT/CN2013/076244

§ 371 Date: Sep. 24, 2015

(51) Int. Cl. H04N 21/4788; H04N 21/258; H04N 21/25

(52) U.S. Cl. CPC H04N 21/4788; H04N 21/252; H04N 21/25891

(57) ABSTRACT

A multimedia processing apparatus includes a controller and a network module. The controller controls the multimedia processing apparatus to perform an application by setting control parameters to sub modules of the multimedia processing apparatus. The network module communicates to a social networking service server through a network. The controller is configured to generate and transmit at least one of setting information, favorite information and current viewing channel information to the social networking service server through the network module and the network. The setting information, the favorite information and current viewing channel information includes control parameters.

### CROSS REFERENCE TO RELATED APPLICATIONS

This application is a National Phase of PCT Application No. PCT/CN2013/076244, filed on May 27, 2013, the entire contents of which are hereby incorporated by reference.

### TECHNICAL FIELD

The invention relates to digital televisions, and more particularly to network applications of digital televisions.

### BACKGROUND

Conventional televisions are analog televisions which process analog signals. On the contrary, digital televisions process video and audio data with the digital format. Moreover, digital televisions is able to handle data transmitted to and received from a network and therefore are often equipped with networking capabilities.

Social networking applications, such as the social networking service provided by Facebook, are prevalent. Users, however, can only enjoy the social networking services via computers. Because digital televisions also have networking capabilities, if the digital televisions are also equipped with social networking applications, users can interact with each other via digital televisions, and the pleasure of watching the digital televisions is greatly improved. Thus, digital televisions with social networking applications are provided.

### SUMMARY

The invention provides a multimedia processing apparatus. In one embodiment, the multimedia processing apparatus comprises a controller and a network module. The controller controls the multimedia processing apparatus to perform an application by setting control parameters to sub modules of the multimedia processing apparatus. The network module communicates to a social networking service server through a network. The controller is configured to generate and transmit at least one of setting information, favorite information and current viewing channel information to the social networking service server through the network module and the network. The setting information, the favorite information and current viewing channel information comprises control parameters.

The invention also provides a method for operating a multimedia processing apparatus. In one embodiment, the method comprises the following steps: controlling the multimedia processing apparatus to perform an application by setting control parameters to sub modules of the multimedia processing apparatus; and generating and transmitting at least one of setting information, favorite information and current viewing channel information to a social networking service server through a network. The setting information, the favorite information and current viewing channel information comprises control parameters.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a network television system according to the invention;

FIG. 2 is a block diagram of a digital television according to the invention;

FIG. 3 is a flowchart of a method for uploading a setting information corresponding to a local digital television to a server according to the invention;

FIG. 4 is a flowchart of a method for performing a favorite function according to the invention;

FIG. 5 is schematic diagram of ranking of favored channels and favored programs according to the invention;

FIG. 6 is flowchart of a method for performing a popularity function according to the invention;

FIG. 7 is a flowchart of a method for accessing information from a server;

FIG. 8 is a flowchart of a method for accessing information from a server according to the invention; and

FIG. 9 is a flowchart of a method for receiving information from network according to the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

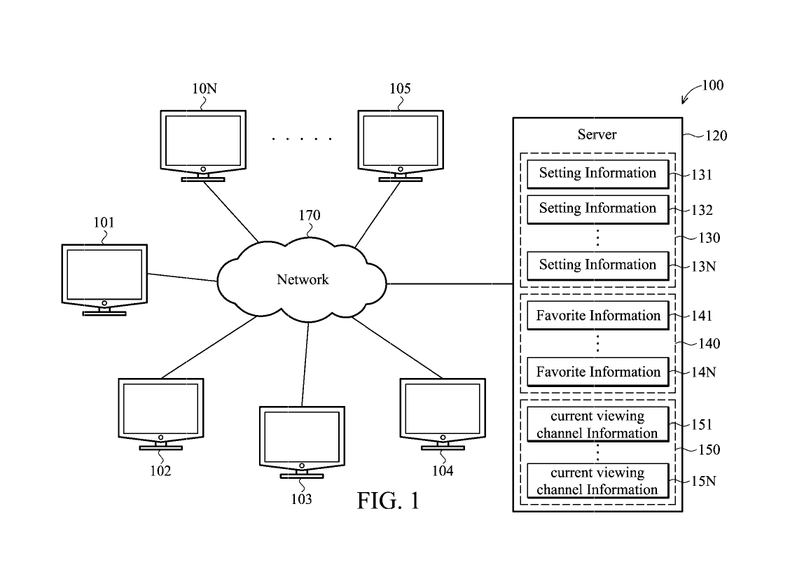

Referring to FIG. 1, a block diagram of a network multimedia processing system 100 according to the invention is shown. In one embodiment, the network multimedia processing system 100 includes a plurality of multimedia processing apparatus, e.g. digital televisions 101˜10N, a network 170, and a server 120. The digital televisions 101˜10N are connected to the network 170 and can communicate with each other via the network 170. The digital televisions 101˜10N are also coupled to the server 120 via the network. The server 120 provides social networking services to users of the digital televisions 101˜10N.

In one embodiment, each of the digital televisions 101˜10N is controlled by a user so as to perform a lot of applications, e g tuning and displaying TV program, connecting to internet through network, adjusting the picture quality related settings, and adjusting audio related settings. The picture quality related settings includes resolution setting, sharpness setting, color temperature setting, brightness setting etc. The audio related settings include volume setting, sound equalization setting etc. The digital television, e.g. digital television 101, has a lot of modules e.g. tuner, demodulator, demultiplexer, video processor, audio processor, and TV controller. Each of the modules performs a specific function. The TV controller controls the operation of the modules in the digital television by setting control data and/or control parameters to the modules so as to perform the applications. The modules conduct the specific functions according to the control data and/or control parameters received from the TV controller and/or received from other modules.

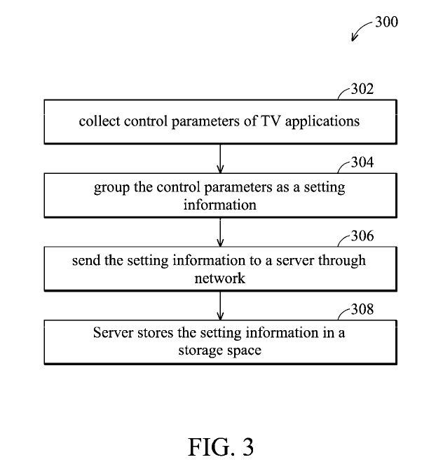

In order to share or exchange information with friends through internet social networking, e.g. Facebook, the digital television 101 collects control parameters corresponding to the applications as a setting information 131, and sends the setting information 131 to the server 120 via the network 170. The server 120 receives the setting information 131˜13N from the digital television 101˜10N through the network 170, and stores the setting information 131˜13N in a storage space 130. The setting information 131˜13N each contains user identification information as well as the control parameters of the application operated by the user of the respective digital television 101˜10N. The digital television 101, maybe under a demand of a user A, accesses some of the setting information 132˜13N which corresponds to watching activities of a user B who is a friend of the user A. For example, the digital television 101 under the control of the user A sends a request to the server 120 for requesting setting information 132 corresponding to the watching activities of the user B. The server 120 then sends the setting information 132 to the digital television 101 via the network 170. After receiving the setting information 132, the TV controller of the digital television 101 can then adjust the control parameters of corresponding modules thereof according to the setting information 132. The aforementioned application is further illustrated in detail with FIGS. 3, 7, 8 and 9.

The digital television 101 receives multimedia signals transmitted through various channels, and the digital television 101 display video data of one of the multimedia signals on a screen of the digital television 101. In one embodiment, when a user of a digital television likes the displayed video program or the channel, the displayed video program is determined to be a favored program, or the channel is determined to be a favored channel. The digital television collects program information of the favored video program and/or the channel information of the favored channel. The program information may include program title, program abstract, program length, start time and end time of the program, program ID, language information, video format and audio format etc. The channel information may include channel name, channel number, channel ID, and channel frequency etc. The digital television sends those collected program information and collected channel information as favorite information to the server 120 via the network 170. The server 120 receives those favorite information 141˜14N from the digital televisions 101˜10N via the network 170, and stores the favorite information 141˜14N in the storage space 140. The favorite information contains user identification information as well we the program information of a favored program and/or the channel information of the favored channel.

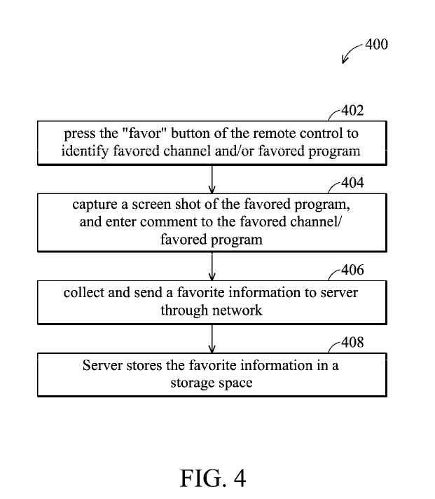

The server 120 determines and ranks favored programs and/or favored channels shared by the users of the digital televisions 101˜10N according to the received favorite information 141˜14N. The digital televisions 101˜10N can then retrieve the ranking of the favored programs and the ranking of the favored channels from the server 120 via the network 170. The ranking of the favored program and the favored channel can be treated as recommend reference information to a user while he/she watches the digital television. The aforementioned application is further illustrated in detail with FIGS. 4, 7, 8 and 9.

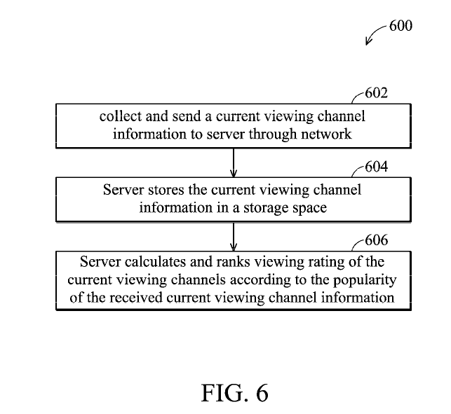

In one embodiment, when a user of a digital television is watching a channel, the digital television sends current viewing channel information to the server 120 via the network 170. The server 120 receives a current viewing channel information 151˜15N from the plurality of digital televisions 101˜10N via the network 170, and stores the current viewing channel information 151-15N in the storage space 150. The server 120 then determines and ranks viewing rating of the current viewing channels according to the popularity of the received current viewing channel information 151˜15N. The digital televisions 101˜10N can then retrieve the ranking of the currently most popular viewing information from the server 120 via the network 170. The ranking of the currently most popular viewing information can be treated as recommend reference information to a user who watches the digital television. The aforementioned application is further illustrated in detail with FIGS. 6, 7, 8 and 9.

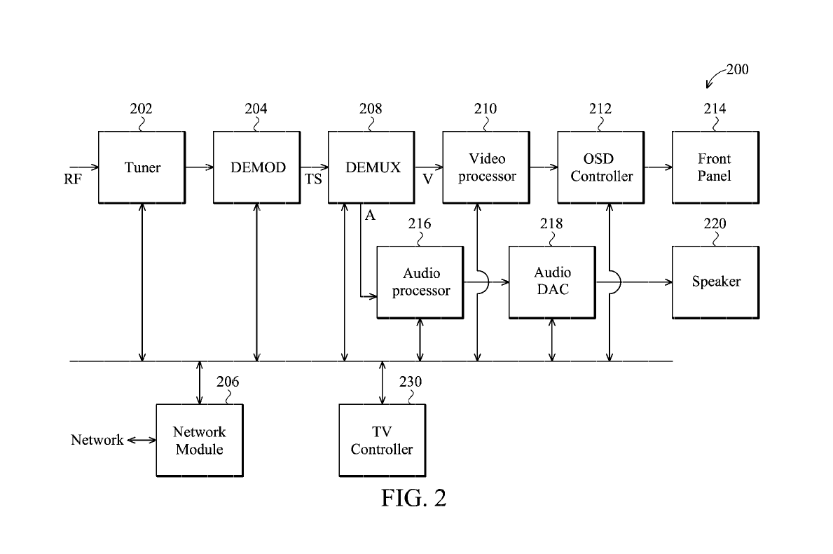

Referring to FIG. 2, a block diagram of a digital television 200 according to the invention is shown. In one embodiment, the digital television 200 includes TV controller 230 and sub-modules. The sub-modules are controlled by the TV controller 230 and includes a tuner 202, a demodulator (DEMOD) 204, a network module 206, a demultiplexer (DEMUX) 208, a video processor 210, an on-screen display (OSD) controller 212, a front panel display 214, an audio processor 216, an audio signal Digital-to-Analog converter (DAC) 218, and a speaker 220. The digital television 200 receives a RF signal from an antenna (not shown) or a cable (not shown). The tuner 202 controlled by the TV controller 230 to select a specific frequency band of the RF signal, and sends the specific frequency band RF signal to the demodulator 204. The demodulator 204 controlled by the TV controller 230 to demodulate the specific frequency band of RF signal to generate a transport stream (TS). The transport stream contains multiplexed video data, audio data and information data. The demultiplexer 208 controlled by the TV controller 230 to filter desired audio data and desired video data from the transport stream, transmits the desired audio data to the audio processor 216, and transmits the desired video data to the video processor 210. The video processor 210 controlled by the TV controller 230 to processe the video data to generated video image and sends the video image to the front panel display 214 for displaying. The audio processor 216 controlled by the TV controller 230 to process the audio data, and sends the processed audio signal to the speaker 220 through the audio DAC 218. The on-screen display (OSD) controller 212 controlled by the TV controller 230 to generate an OSD image and superpose the OSD image with the video image. The audio signal DAC 218 controlled by the TV controller to convert the digital audio signal to analog audio signal. The network circuit 206 is controlled by the TV controller 230 to receive input data from the network, and transmit output data to the network. The television controller 230 receives data and/or status information from sub-modules and controls the sub-modules by delivering control data and/or control parameters to sub-modules.

Referring to FIG. 3. FIG. 3 shows a flowchart of a method 300 for uploading setting information corresponding to a local digital television to a server 120 according to the invention. First, the TV controller 230 of a local digital television 200 collects control parameters of applications (step 302). The TV controller 230 groups the control parameters as a setting information (step 304). The setting information contains user identification information as well as the control parameters of the application. And the setting information may be compliant with a specific format, e.g. eXtensible Markup Language (XML). The TV controller 230 of the local digital television 200 then controls the network module 206 to send the setting information to the server 120 through the network 170 (step 306). In one embodiment, the server 120 may be a server containing a social networking service such as Facebook. The server 120 then stores the setting information in a storage space 130 (step 308).

In one embodiment, the control parameters include channel information, program information, picture quality related settings, and audio related settings. For example, the channel information includes channel name, channel number, channel ID, or channel frequency etc. The program information includes program title, program abstract, program length, start time and end time of the program, program ID, language information, video format or audio format etc. The picture quality related settings include resolution setting, sharpness setting, color temperature setting, or brightness setting, etc. The audio related settings include volume setting or sound equalization settings, etc. Some of the control parameters, e.g. sharpness setting, brightness setting, and volume setting are represented by ration (or percentage) of the maximum adjustable range of the parameter.

Referring to FIG. 4, a flowchart of a method 400 for performing a favorite function according to the invention is shown. Assume that a remote control of a local digital television 200 has a “favor” button or other operation scheme for selecting a favored program/channel. The local digital television receives multimedia signals transmitted through various channels, and the local digital television display video data of one of the multimedia signals on a screen. If a user of the local digital television likes the watched channel or program, the user can press the “favor” button of the remote control to identify his/her favored channel and/or favored program (step 402). The local digital television 200 may capture a screen shot of the favored program, and the user may enter some comment to the favored channel/favored program (step 404), collects a user identification, the screenshot, the comment, the channel information of the favored channel and/or the program information of the favored program as a favorite information, and sends the favorite information 141 to the server 120 through the network 170 (step 406). The server 120 receives and stores the favorite information 141 in the storage space 140(step 408). In one embodiment, the server 120 may publish the screenshot and the channel information of the favored channel and/or the program information of the favored program in a web space. Thus, other users can access the favorite information 140˜14N via the network 170.

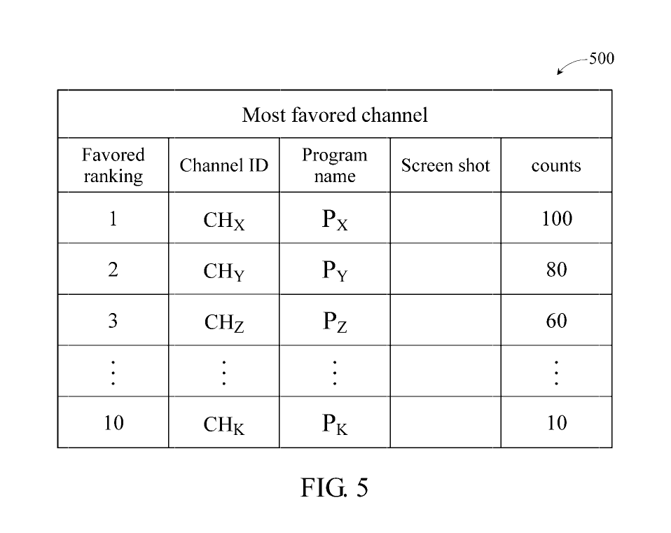

In one embodiment, the server 120 receives a plurality of favorite information 141˜14N from the plurality of digital televisions 101˜10N. And the server 120 stores the favored information 141˜14N respectively corresponding to users. The server 120 then determines and ranks favored programs and/or favored channels shared by the users of the digital televisions 101˜10N according to the received favorite information 141˜14N. Referring to FIG. 5, a schematic diagram of ranking of favored channels and favored programs according to the invention is shown. For example, the channel CH_{X} has been ranked as the highest favored channel since it has been recognized by 100 users or times; the channel CH_{Y} has been ranked a second highest favored channel since it has been recognized by 80 users or times. The users of the digital televisions 101˜10N can therefore retrieve the ranking of the favored channel and ranking of the favored program from the server 120 via the network 170. The ranking of the favored program and ranking of the favored channel can be treated as recommend reference information to a user while he/she watches the digital television.

Referring to FIG. 6, a flowchart of a method 600 for performing a popularity function according to the invention is shown. The local digital television receives multimedia signals transmitted through various channels, and the local digital television display video data of one of the multimedia signals on a screen. When a user of a digital television 101 is watching a channel, the digital television 101 collects a user identification, channel information, and/or program information of the currently watched channel/program as a current viewing channel information 151, and the digital television 101 sends the current viewing channel information 151 to the server 120 via the network 170 (step 602). The server 120 receives current viewing channel information 151˜15N from the plurality of digital televisions 101˜10N via the network 170, and stores the current viewing channel information 151˜15N in the storage space 150 (step 604). The server 120 then calculates and ranks viewing rating of the current viewing channels according to the popularity of the received current viewing channel information 151˜15N (step 606), wherein a channel with the highest viewing frequency is determined to be the most popular channel.

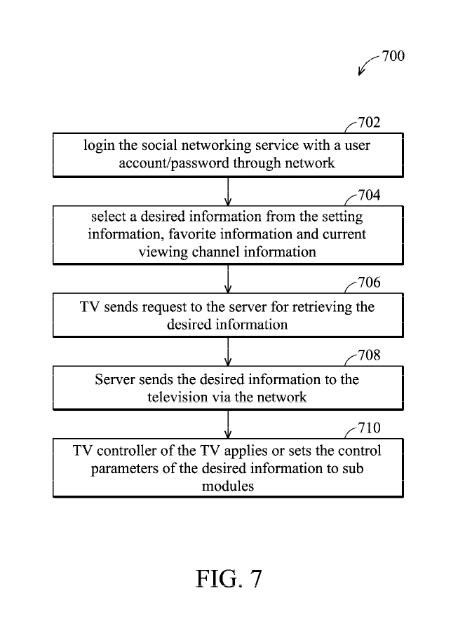

Referring to FIG. 1,2 and FIG. 7, FIG. 7 shows a flowchart of a method 700 for accessing information from a server 120. As shown in FIG. 1, the server 120 stores a plurality of setting information 131˜13N, a plurality of favorite information 141˜14N, and a plurality of current viewing channel information 151˜15N, which each of those information represents a user's watching activities and contains a user identification. Those users may be friends, therefore the server 120 of the social networking service may share those setting information 131˜13N, favorite information 141˜14N and current viewing channel information 151˜15N to each friends. Since the setting information 131˜13N, the favorite information 141˜14N and the current viewing channel information 151˜15N stored in the server 120 are previously uploaded by the digital televisions 101˜10N through the network 170, through such sharing mechanism, a local digital television 200 is able to access the server 120 to access other users' (e.g. friends') setting information 131˜13N, favorite information 141˜14N and current viewing channel information 151˜15N. The local digital television 200 can be controlled by the TV controller 230 to apply the same control parameters contained in the received setting information 131˜131N, favorite information 141˜14N or current viewing channel information 151˜15N to sub-modules so as to perform the same or similar applications which their friends also performed.

Please refer to FIG. 7, first, a first user of the local digital television 200 login the social networking service with a user account (and/or a password) through network 170 (step 702). Second, the first user selects a desired information from the setting information 131˜13N, favorite information 141˜14N and current viewing channel information 151˜15N which is uploaded from his friends (step 704). In one embodiment, the desired information can be selected according to a manual mode or an automatic mode. In the automatic mode, the desired information is predetermined set by the first user. In other word, the automatic mode, the first user preset default settings in the local television 200 and/or in the social networking service, so that the local digital television 200 can automatically follow the watching TV activities of the friend. The default settings may include the first user's user account and/or password of the social networking service and at least one friend's user identification. In the manual mode, the first user of the local digital television 200 manually selects the desired information from the setting information 131˜13N, favorite information 141˜14N and current viewing channel information 151˜15N which are uploaded by his friends (e.g. a second user). After the desired information is determined, the local digital television 200 sends a request to the server 120 for retrieving the desired information (step 706). The server 120 sends the desired information to the local digital television 200 via the network (step 708). The TV controller 230 of the local digital television 200 then applies or sets the control parameters of the received desired information to sub modules accordingly thus to perform the same or similar applications which their friends also performed (step 710).

According to FIG. 2 & FIG. 7, the TV controller 230 may apply the parameters of channel frequency to the tuner 202 for tuning a specific frequency RF signal. The TV controller 230 may apply parameters of the channel ID, the program ID, and the language information to the demultiplexer 208 for filtering video data, audio data. The TV controller 230 may apply the parameters of picture quality related settings to the video processor 210 and OSD controller 212 to adjust the resolution setting, brightness setting, sharpness setting and/or color temperature setting of the local digital television 200. Further the TV controller 230 may apply the parameters of audio related settings to the audio processor 216 and the audio ADC 218 to adjust the volume setting or sound equalization settings.

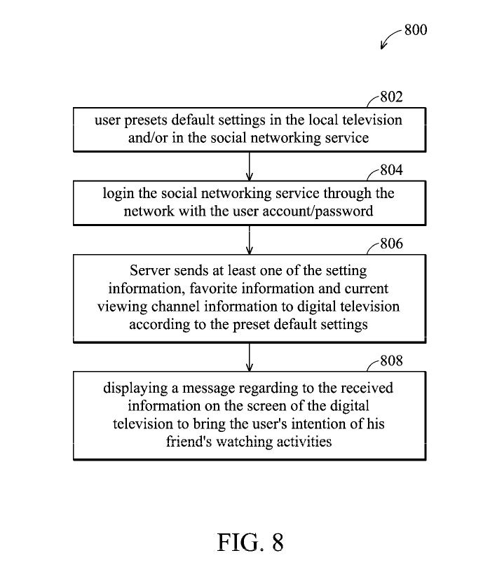

Referring to FIG. 8, a flowchart of a method 800 for accessing information from a server 120 according to the invention is shown. If a first user would like to follow a friend's watching activities. The first user could preset a default setting in the local television 200 and/or in the social networking service (step 802). The default setting may include the friend's user identification. Second, the local digital television 200 logins the social networking service through the network 170 with a user account (and/or the password) (step 804). After the local digital television log into the social networking service, the server 120 sends at least one of the setting information 131˜13N, favorite information 141˜14N and current viewing channel information 151˜15N to the local digital television 200 according to the preset default settings(step 806). The local digital television 200 then displaying a message regarding to the received information on the screen of the local digital television 200 to bring the first user's intention of his friend's watching activities (step 808). In one embodiment, the server 120 sends the latest one of the setting information 131˜13N, favorite information 141˜14N and current viewing channel information 151˜15N to the local digital television 200 according to the preset default settings.

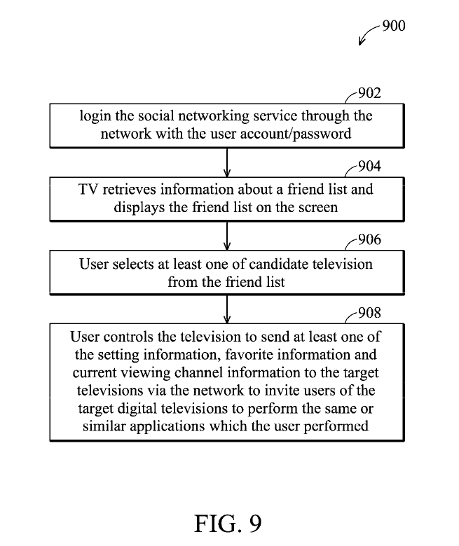

Referring to FIG. 9, a flowchart of a method 900 for receiving information from network 170 according to the invention is shown. First, a first user of the local digital television 200 logins the social networking service through the network 170 with the user account (and/or the password) (step 902). Second, the local digital television 200 retrieves information about a friend list and displays the friend list on the screen (step 904). The friend list includes a plurality of user identifications, each corresponding to a candidate television. The user can then select at least one of candidate television from the friend list (step 906). The first user then controls the local digital television 200 to send at least one of the setting information 131˜13N, favorite information 141˜14N and current viewing channel information 151˜15N to the target digital televisions via the network 170 to invite users of the target digital televisions to perform the same or similar applications which the first user also performed (step 908).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A multimedia processing apparatus, comprising:
a controller controlling the multimedia processing apparatus to perform an application by setting control parameters to sub modules of the multimedia processing apparatus; and
a network module, controlled by the controller, for communicating to a social networking service server through a network;
wherein the controller is configured to generate and transmit at least one of setting information, favorite information and current viewing channel information to the social networking service server through the network module and the network; and
wherein the setting information, the favorite information and current viewing channel information comprises control parameters.

2. The multimedia processing apparatus as claimed in claim 1, wherein the setting information comprises a first user identification information and the control parameters of the application.

3. The multimedia processing apparatus as claimed in claim 2, wherein the control parameters of the application comprises at least one of channel information, program information, picture quality related settings, and audio related settings.

4. The multimedia processing apparatus as claimed in claim 1, wherein the favorite information comprises a first user identification information and favored channel/program information.

5. The multimedia processing apparatus as claimed in claim 4, wherein the favorite information further comprises at least one of a screenshot and a comment of the favored channel/program.

6. The multimedia processing apparatus as claimed in claim 1, wherein the current viewing channel information comprises a first user identification information and channel/program information of the currently watched channel/program.

7. The multimedia processing apparatus as claimed in claim 1, wherein the multimedia processing apparatus further receives at least of the setting information, favorite information and current viewing channel information corresponding to a second user identification information from the social networking service server.

8. The multimedia processing apparatus as claimed in claim 7, wherein the controller applies the control parameters of the received setting information, favorite information or current viewing channel information to sub modules of the multimedia processing apparatus for performing the same or similar application which also performed by a user of the second user identification information.

9. A method for operating a multimedia processing apparatus, comprising:
controlling the multimedia processing apparatus to perform an application by setting control parameters to sub modules of the multimedia processing apparatus; and
generating and transmitting at least one of setting information, favorite information and current viewing channel information to a social networking service server through a network;
wherein the setting information, the favorite information and current viewing channel information comprises control parameters.

10. The method as claimed in claim 9, wherein the setting information comprises a first user identification information and the control parameters of the application.

11. The method as claimed in claim 10, wherein the control parameters of the application comprises at least one of channel information, program information, picture quality related settings, and audio related settings.

12. The method as claimed in claim 9, wherein the favorite information comprises a first user identification information and favored channel/program information.

13. The method as claimed in claim 12, wherein the favorite information further comprises at least one of a screenshot and a comment of the favored channel/program.

14. The method as claimed in claim 9, wherein the current viewing channel information comprises a first user identification information and channel/program information of the currently watched channel/program.

15. The method as claimed in claim 9, further comprising:
receiving at least of the setting information, favorite information and current viewing channel information corresponding to a second user identification information from the social networking service server.

16. The method as claimed in claim 15, further comprising:
applying the control parameters of the received setting information, favorite information or current viewing channel information to sub modules of the multimedia processing apparatus for performing the same or similar application which also performed by a user of the second user identification information.
